(19) United States
(12) Patent Application Publication
(10) Pub. No.: US 2011/0011662 A1
(43) Pub. Date: Jan. 20, 2011

(54) MULTI-FUNCTION TANK

(75) Inventors: Leo P. Oriet, Rochester Hills, MI (US); Jules Cazabon, Staples (CA)

Correspondence Address: NAVISTAR CANADA, INC.;C/O Navistar, Inc., 4201 WINFIELD ROAD, P.O. BOX 1488, WARRENVILLE, IL, 60555, US

(73) Assignee: International Truck Intellectual Property Company, LLC, Warrenville, IL (US)

(21) Appl. No.: 12/503,401

(22) Filed: Jul. 15, 2009

(51) Int. Cl. B60R 16/04; H01M 6/42; H01M 6/50

(52) U.S. Cl. 180/68.5; 429/150; 429/120

(57) ABSTRACT

A vehicle sub-structure includes an array of electrical power cells, the electrical power cells being ordered into groups of serially connected cells. A switch set provides for selectively interconnecting the plurality of groups of electrical power cells in a selected one of a plurality of possible orders, allowing the first and last cell in the series of cells to be changed. An auxiliary storage element is nested within the electrical power cells and both the auxiliary storage element and the arrays of electrical power cells are housed in a conformal enclosure.

### BACKGROUND

1. Technical Field

The technical field relates generally to installation of battery arrays or packs and the storage of fluids and power on motor vehicles.

2. Description of the Problem

Packaging arrays of batteries for installation on trucks, particularly where the arrays include a large plurality of batteries or cells, as is common on hybrid vehicles, presents several issues. Battery boxes for conventional trucks can be hung from the vehicle frame rails toward the outside of the vehicle. Their location there allows them covered by a tractor side skirt to protect the batteries, streamline the vehicle and meet styling expectations, while still being accessible for service. The battery arrays designed to meet the traction voltage used on hybrid vehicles typically include many more cells or batteries than are used on non-hybrid vehicles. In order to provide a 345 volt traction power supply up to 96 lithium-ion cells may be used. Hybrid vehicle battery arrays are, as a result, typically bulkier than the two to four battery arrays used on non-hybrid vehicles.

Simple expansion of a conventional battery box to handle the bulkier array is difficult to accommodate and can lead to relocation of the box on vehicles where open space is restricted or exposure of the box without the protection of an external skirt. Such a location can also affect the vehicle's aerodynamics. Location of the batteries also has consequences relating to access to the batteries for maintenance. Any one of several factors, such as battery numbers, their location relative to external connections, or the use of lithium ion batteries in the array, can result in increased generation or retention of battery internal heat during charging or discharging. Prolonged exposure to high levels of retained heat can lead to reduced battery service lives. Prolonged positioning of particular cells at the head or tail of a plurality of cells connected serially contributes to a shortened service life.

### SUMMARY

A vehicle sub-structure includes an array of electrical power cells. The electrical power cells are ordered into groups of serially connected cells. A switch set provides for selectively interconnecting the plurality of groups of electrical power cells in a selected one of a plurality of possible orders, allowing the first and last cell in the series of cells to be changed. An auxiliary storage element is nested within the electrical power cells and both the auxiliary storage element and the arrays of electrical power cells are housed in a conformal enclosure.

### BRIEF DESCRIPTION OF THE DRAWINGS

FIG. 1 is a perspective view of a vehicle equipped with a conformal multi-function auxiliary tank.

FIG. 2 is a side elevation illustrating location of the auxiliary tank of FIG. 1 on a truck behind a chassis skirt.

FIG. 3 is a side elevation of an multi-function auxiliary tank.

FIGS. 4A-B are end views of the auxiliary tank of FIG. 3.

FIG. 5 is an exploded view of a possible set of elements for the auxiliary tank of FIG. 3 illustrating positioning of the elements.

FIG. 6 is a cross sectional view of the auxiliary tank of FIG. 3 taken lengthwise.

FIGS. 7A-B are cross sectional views taken along section line 7A-B of FIG. 6.

FIG. 8 is a detailed view of a representative battery band assembly.

FIG. 9 is a cross sectional view taken along section line 9 of FIG. 6.

### DETAILED DESCRIPTION

In the following detailed description, like reference numerals and characters may be used to designate identical, corresponding, or similar components in differing drawing figures. Furthermore, example sizes/models/values/ranges may be given with respect to specific embodiments but are not to be considered generally limiting. In circuit diagrams well-known power and ground connections, and similar well-known elements, may be omitted for the sake of simplicity of illustration.

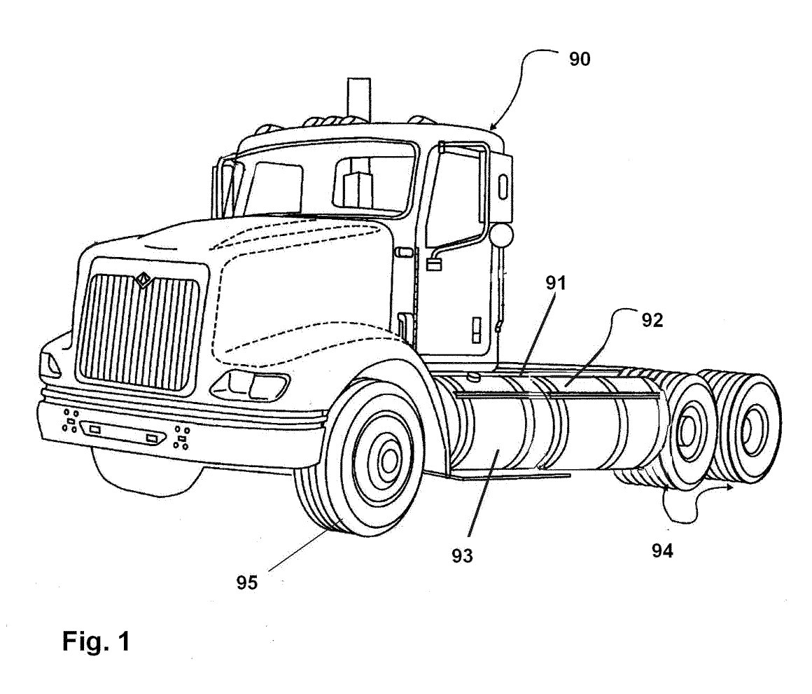

FIG. 1 shows a truck 90 supported from front wheels 95 and rear wheels 94. Truck 90 is built on a frame which includes a side frame rail 91 which is parallel to the longitudinal center line of the vehicle. Frame rail 91 carries a cylindrical fuel tank 93 hung from the frame rail toward the outside of the vehicle. A similar tank may be hung from a passenger side frame rail (not shown). Also hung from the frame rail 91 behind the fuel tank 93 and forward from the rear wheels 94 is a multi-function or auxiliary tank 92. Multi-function tank 92 may be built to conform in cross sectional shape and dimensions (width and breadth) to the fuel tank 93, though it can readily vary in length. Multi-function tank 92 can operate as an enclosure for any two or more of a plurality of storage elements, such as electrical power storage elements, pressurized fluid storage tanks, liquid storage tanks, etc. A gap may be left between the fuel tank 93 and the multi-function tank 92 to allow access to the ends of the tank for maintenance procedures, as explained below. As illustrated here both the fuel tank 93 and the multi-function tank 92 are cylinders.

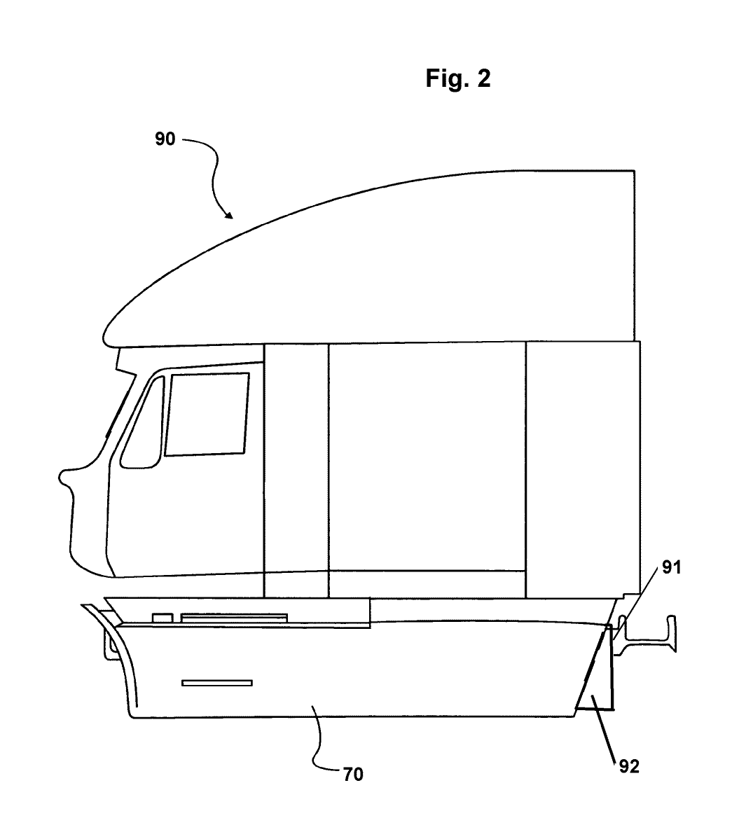

Some trucks a equipped with chassis skirts for reasons of styling and streamlining. An example of a truck 90 equipped with a chassis skirt 70 with a multi-function tank 92 hung from the frame rail 91 and extending just past the end of the chassis skirt 70 is shown in FIG. 2.

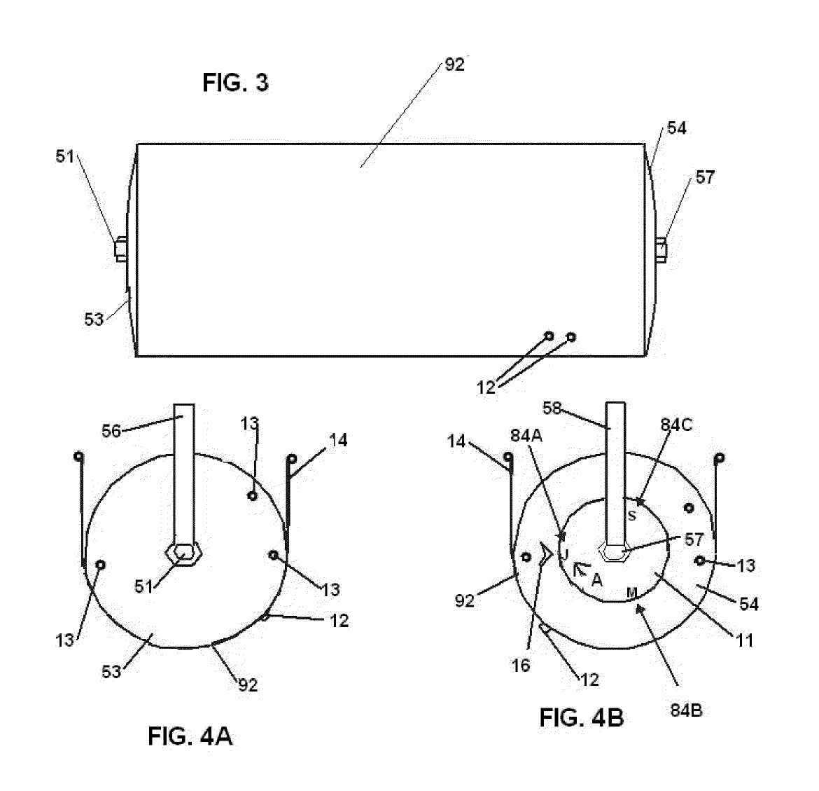

FIG. 3 shows the exterior of one side of a multi-function tank 92. Multi-function tank 92 is cylindrical and closed at each end by end caps 53, 54. Tank outlet ports 51, 57 are provided at each end for the connection of conduits through which cables may be run to the tank or fluids introduced or withdrawn. Heat exchanger fluid ports 12 may be located along the side of the multi-function tank 92. The contents of multi-function tank 92 may be cooled or heated depending upon the application.

Multi-function tank 92 is employed as a storage vessel for fluids or components used for the storage of electrical energy, usually capacitors or battery cells. Multi-function tank 92 may be used as the location for batteries and capacitors, and for the storage of fluids including compressed gases such as air or propane, liquefied natural gas, engine coolant, hydraulic oil, engine oil, deicer, urea, diesel fuel or other substances.

FIGS. 4A-B show opposite ends of multi-function tank 92. Multi-function tank 92, when cylindrical may be suspended from a frame rail by conventional tank straps 14 as used with cylindrical fuel tanks. Conduits 56, 58 are shown connected to tank outlet ports 51, 57. Removable end caps 53, 54 are aligned on the tank 92 by alignment studs 13. Conventional fasteners may be used to secure the end caps 53, 54 on the tank 92.

Where tank 92 is used for locating a plurality of batteries, particularly an array of lithium-ion cells connected in series for a hybrid vehicle, end cap 54 may be modified to incorporate a battery rotation plate indicator dial 11. As described below, on hybrid vehicles, the traction battery cells are typically connected in series to build a battery having an operational voltage of approximately 345 volts. If the order of the cells in the series is left unchanged, the cells at the beginning and end of the chain tend to exhibit premature failure, potentially leading to a cascade failure of all the cells in the chain resulting in the expensive replacement of the cells. Battery rotation plate indicator dial is used to change the order of the cells in the chain to alter which cells are at the beginning and end of the chain.

As illustrated, an operator can select any of three cells (here out of 36 or 48 cells) for location at the head of the chain and three cells for location at the tail of the chain. This does not involve actual physical repositioning of the batteries, but a change in wiring implemented with rotation of the indicator dial 11 in the direction indicated by the letter A. A handle (not shown) may be added to the face of indicator dial 11 to ease lifting and rotation of the indicator dial. Three stops of the indicator dial are associated with the set point markers 84A, B and C, marked as J, M and S. The letters used are associated with the months of January, May and September, which may be used as recommended times of the year for changing the battery cell order. The particular start dates for operating periods are arbitrary, and there is no particular significance to January, May and September. Selection of a particular order for the cells is done by positioning one of the set point markers 84A, B or C proximate to a battery rotation plate service alignment indicator 16.

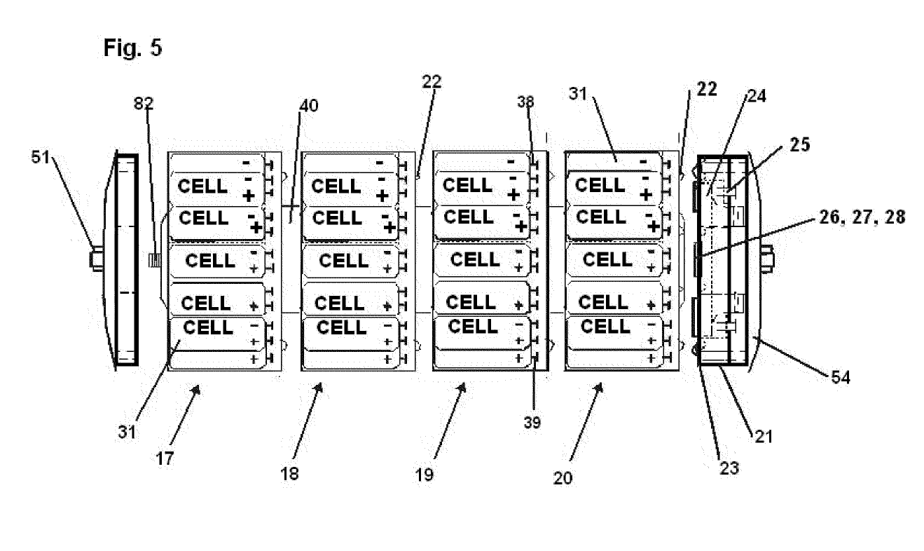

Referring to FIG. 5, an exploded view of the contents of a multi-function tank 92 used for battery storage of electrical power for a hybrid vehicle. A secondary tank 40 is located centered within four radial battery bands 17, 18, 19 and 20. Secondary tank 40 may be used for storage of a large variety of liquids or gases, or could be a capacitor. Tank 40 has a threaded tank connector 82 for connection to tank outlet port 51.

A typical arrangement of cells 31 for location in multi-function tank 92 are in four radial groups of twelve cells each. This arrangement works for lithium ion cells having a nominal output voltage of about 3.6 volts. Ninety six cells may be used to build a traction battery having a nominal output voltage of 345 volts. With 48 cells per multi-function tank 92, and two multi-function tanks, 96 cells may be connected in series to provide a theoretical output voltage of 345.6 volts, disregarding resistance losses. Each cell has a positive terminal 39 and a negative terminal 38.

Cells 31 are arranged in radial bands circumscribing tank 40. The number of bands is variable with four bands 17, 18, 19 and 20 of twelve cells 31 each shown. Alternatively two or three bands may be used with differing numbers of cells. Each band includes heat exchanger lines 22, which connect to one another between bands and from band to the heat exchanger outlet ports 12. Typically the concern is for cooling of the batteries, and the heat exchanger lines 22 may be connected to an external heat sink (not shown) and coolant circulated through the lines by a pump (also not shown) and in theory can be used to transfer heat in or out of the system. Under some circumstances the cells may be warmed by circulated heated coolant through the lines 22.

Attached behind end cap 54 between the end cap and battery band 20 is a battery control electrical assembly 21 which includes a battery rotation switch assembly 24. Battery control electrical assembly 21 is aligned on band 20 using battery switch plate alignment elements 23. Battery rotation switch assembly 24, except during rotation of one of the plates of the battery rotation switch assembly 24, holds electrical contacts 26, 27, 28 in electrical contact. Assembly 24 is held in mechanical linkage to indicator dial 11 by threaded fasteners 25. Electrical cables (described below) from each of the bands 17, 18, 19 and 20 are connected to selected electrical contacts 27, 28 in the switch assembly 24 allowing selection of which band includes the cell 31 to be at the base of the chain of cells 31 and which band is to include the cell at the head of the chain.

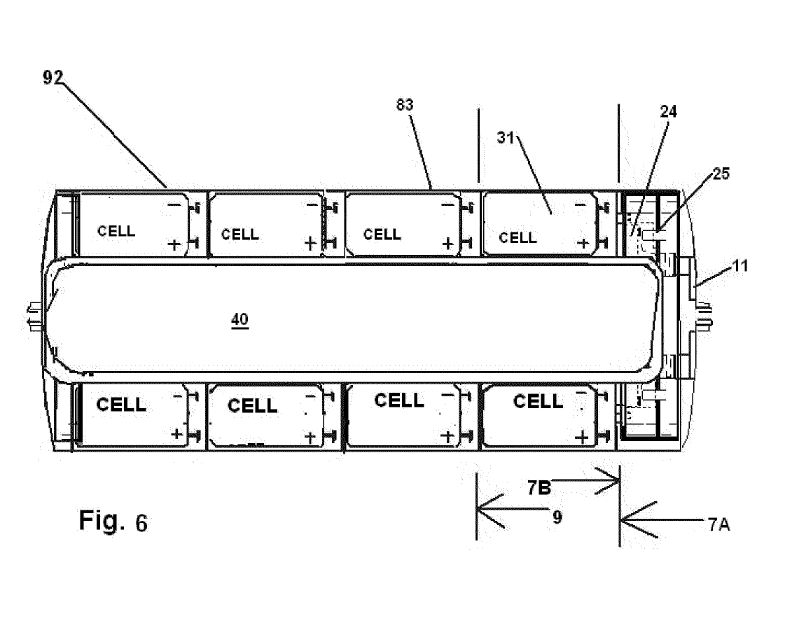

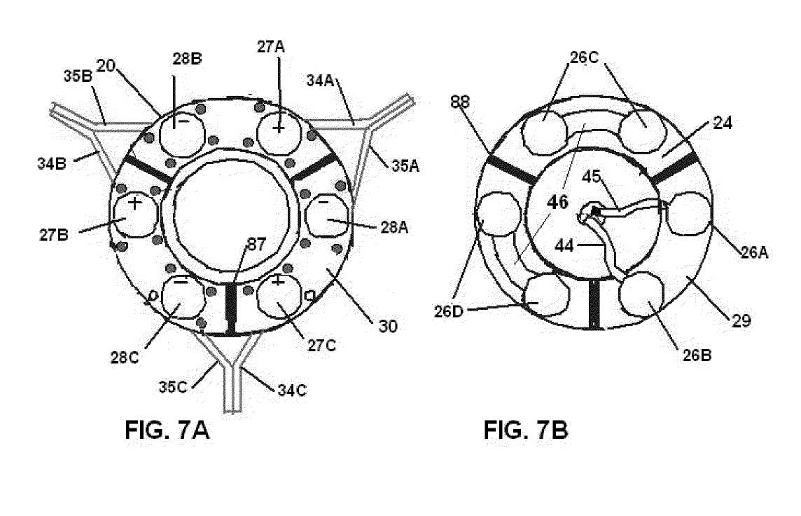

FIG. 6 illustrates in cross section the assembled multi-function tank with cells circumscribing auxiliary tank 40. The location and direction of cross-sectional views illustrating electrical connection of the cells 31 in FIGS. 7A, 7B and 9 is shown. The battery assembly and tank 40 are enclosed within the tank wall 83 of the multi-function tank 92.

Referring to FIGS. 7A and 7B a rotation plate 29 and a fixed plate 30 of the battery rotation switch assembly 24 are shown. Rotation plate 29 and fixed plate 30 face one another in the assembly 24 to contact pads 26 of the rotation plate 29 and the fixed plate negative contacts 27A, 27B, 27C and fixed plate positive contacts 28A, 28B, 28C. Rotation plate 29 and fixed plate 30 are set up with three sets of electrical contacts for three groups or “bands” of cells and to allow selection of which band will include the base cell 31 and which band will include the head cell 31 of the series. Rotation plate 29 may be mechanically linked to indicator dial 11 to indicate the relative rotational relationship between plates 28 and 29. Three rotational relationships between plates 29 and 30 are defined by tongue and groove system locks 87, 88. The plates 29, 30 may be urged together by a spring, but can come together for electrical contact only if the tongues 87 are aligned with the grooves 88. It is arbitrary which plate carries the tongues and which carries the grooves.

Two sets of contacts 26C and 26D are electrically shorted using jumpers 46. Contacts 26C and 26D provide electrical connection between bands or groups of cells. Contacts 26A and 26B define the base and head cell 31 of the series by not being jumped to one another but instead being connected to positive and negative main output cables 44 and 45.

Fixed plate 30 has three positive contacts 27A, B and C and three negative contacts 28A, B and C. Electrical cables 34A, B and C are connected from a positive terminal on a cell in one each of the bands to a positive contact 27 on the fixed plate 30. Electrical cables 35A, B and C are connected between a negative terminal on a cell in one of the bands and one of the negative contacts 28.

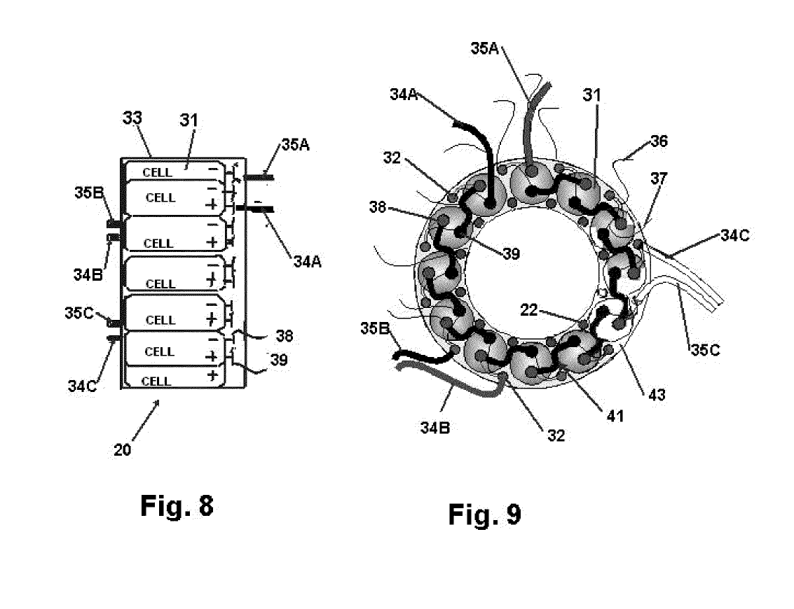

FIGS. 8 and 9 illustrate pass through of cable sets 34B, 35B and 34C, 35C from lower bands of an array via pass through wiring pass through holes 32 through a cell frame 43 for connection to the fixed plate 30. Cable set 34A, 35A may be directly connected to the fixed plate 30 without pass through. FIG. 8 shows the distribution of some of the cells 31 within the exterior surface 33 of a battery band assembly.

FIG. 9 illustrates electrical connections within a representative band, here the band adjacent the fixed plate 30. Each cell 31 has a positive and negative terminal 39, 38. Eleven cell cable connectors 41 are provided between positive and negative terminals 39, 38 of adjacent cells 31. One pair of adjacent cells 31 is missing a cell cable connector, with the respective positive and negative terminals being connected to positive and negative cables out 34A, 35A. Depending upon the relative alignments of plates 29 and 30 in the battery switch rotation assembly 24, either the cell 31 connected to cable out 34A will be the last battery in the series connection of cells from band to band, or the cell connected to cable out 35A will be the first or base cell in the series, although if there is more than one band they will never be concurrently in these positions. Battery switch rotation assembly 24 allows the electrical sequence of the bands to be changed.

Signal wires 36, 37 are provided from the cells 31 to an external battery management system.

What is claimed is:

1. A vehicle sub-structure, comprising:
means for arraying pluralities of electrical power cells into a plurality of groups, the plurality of electrical power cells of each of the plurality of groups being connected in series;
a switch set for selectively interconnecting the plurality of groups of electrical power cells in a selected one of a plurality of possible orders; and
a conformal enclosure for the plurality of groups of electrical power cells.

2. The vehicle sub-structure as set forth in claim 1, further comprising:
an auxiliary storage element within the conformal enclosure.

3. The vehicle sub-structure as set forth in claim 2, wherein the auxiliary storage element is
a fluid storage tank.

4. The vehicle sub-structure as set forth in claim 2, wherein the conformal enclosure is a cylindrical tank.

5. The vehicle sub-structure as set forth in claim 1, further comprising:
a fluid storage tank nested within the plurality of groups of electrical power cells.

6. The vehicle sub-structure as set forth in claim 5, further comprising:
means for transferring heat relative to the fluid storage tank and the plurality of groups of electrical power cells.

8. A motor vehicle comprising:
a frame rail;
a storage vessel depending from the frame rail;
an auxiliary vessel located within the storage vessel;
a plurality of electrical power cells arrayed within the storage vessel dispersed around the auxiliary vessel in a plurality of bands; and
switch means for interconnecting the plurality of bands in series in different electrical sequences.

9. The motor vehicle of claim 8, further comprising:
each of the plurality of bands carrying a plurality of electrical power cells with each of the plurality of the electrical power cells being connected in series.

10. The motor vehicle of claim 9, further comprising:
the switch means comprising a rotation plate assembly having a rotatable element and a non-rotatable element; and
an indicator located outside of the storage vessel providing visual indication of sequence in which the plurality of bands are connected.

11. The motor vehicle of claim 10, further comprising:
a linkage for manually rotating the rotatable element.

12. The motor vehicle of claim 9, further comprising:
a fuel tank depending from the frame rail;
the storage vessel conforming in cross-sectional width and height to the fuel tank and being located longitudinally aligned with the fuel tank.

13. The motor vehicle of claim 12, further comprising:
heat transfer lines through the storage vessel.

14. A storage system comprising:
a tank;
an auxiliary vessel located within the tank;
a plurality of electrical power cells located in the tank; and
switch means for interconnecting the plurality of electrical power cells in series in selected sequences.

15. The storage system of claim 14, further comprising:
the plurality of electrical power cells being located radially distributed around the auxiliary vessel in a plurality of bands; and
the electrical power cells of each of the plurality of bands being connected in series.

16. The storage system of claim 15, further comprising:
the switch means being operable to connect the plurality of bands in selected orders; and
selection means accessible externally to the tank for operating the switch means.

17. The storage system of claim 16, further comprising:
the switch means comprising a rotation plate carrying a plurality of electrical contacts and a fixed plate juxtaposed the rotation plate, the fixed plate carrying a plurality of electrical contacts connected to the plurality of electrical power cells of each of the plurality of bands.

18. The storage system of claim 17, further comprising:
coolant tubes disposed adjacent each of the plurality of bands.
